(19) United States
(12) Patent Application Publication
(10) Pub. No.: US 2016/0217780 A1
(43) Pub. Date: Jul. 28, 2016

(54) TIME-DIVISION-MULTIPLEXING BASED NOISE CANCELATION EARPHONE

(71) Applicant: INVENSENSE, INC., San Jose, CA (US)

(72) Inventor: Baris Cagdaser, Sunnyvale, CA (US)

(21) Appl. No.: 14/605,106

(22) Filed: Jan. 26, 2015

(51) Int. Cl. G10K 11/178; H04J 3/00; H04R 1/10

(52) U.S. Cl. CPC G10K 11/1782; H04R 1/1083; H04J 3/00; H04R 2201/003; G10K 2210/1081

(57) ABSTRACT

A time-division-multiplexing (TDM) based noise cancelation headphone is presented herein. A headphone can include an earbud including a speaker, and a TDM based bus that electrically couples the earbud to a portable electronic device. Further, the headphone can include a first micro-electro-mechanical system (MEMS) microphone that is configured to receive a first set of acoustic waves outside of an ear canal, generate first microphone information based on the first set of acoustic waves, and send, utilizing the TDM based bus, the first microphone information directed to the portable electronic device. The speaker is configured to receive, utilizing the TDM based bus, feedforward noise cancelation information associated with the first microphone information from the portable electronic device, and generate, based on the feedforward noise cancelation information, sound within a portion of the ear canal.

### TECHNICAL FIELD

The subject disclosure generally relates to embodiments for a time-division-multiplexing (TDM) based noise cancelation earphone.

### BACKGROUND

Conventional headphone technologies perform noise cancelation to improve user listening experiences. Although such technologies actively reduce noise by phase shifting or inverting the polarity of an original signal, processing power of a host device is not leveraged to perform noise reduction. In this regard, conventional audio technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a headphone including a MEMS microphone, in accordance with various embodiments;

FIG. 2 illustrates a block diagram of another headphone including a MEMS microphone, in accordance with various embodiments;

FIG. 3 illustrates a block diagram of a headphone including MEMS microphones, in accordance with various embodiments;

FIG. 4 illustrates a block diagram of a headphone including MEMS microphones and an inertial sensor, in accordance with various embodiments;

FIG. 5 illustrates a block diagram of another headphone including MEMS microphones and an inertial sensor, in accordance with various embodiments;

FIG. 6 illustrates a block diagram of a headphone including a pair of earbuds, in accordance with various embodiments;

FIG. 7 illustrates a block diagram of portable electronic device, in accordance with various embodiments;

FIG. 8 illustrates a block diagram of another portable electronic device, in accordance with various embodiments;

FIGS. 9-10 illustrate flowcharts of methods associated with a headphone including a MEMS microphone, in accordance with various embodiments; and

FIG. 11 is a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Conventional audio technologies have had some drawbacks with respect to leveraging processing power of a host device when performing headphone noise cancelation. Various embodiments disclosed herein can reduce headphone components and improve noise cancelation performance by utilizing TDM based communication between the headphone components and the host device, e.g., in which the headphone components share a common signal path, e.g., bus, when communicating with the host device.

For example, a headphone can comprise an earbud that comprises a speaker—the earbud placed within portion(s) of an ear canal of an ear. Further, the headphone can comprise a TDM based bus, e.g., a 2-wire bus, a 3-wire bus, a Mobile Industry Processor Interface (MIPI) SoundWire^{SM} based interface, a Serial Low-power Inter-chip Media Bus (SLIMbus^{SM}), etc. that electrically couples the earbud to a portable electronic device, e.g., handheld device, smart phone, cellular phone, etc. In this regard, the TDM based bus can comprise a synchronous TDM frame structure, e.g., in which a data line (e.g., DATA) and a clock line (e.g., CLK) interconnect multiple components, e.g., headphone components, with the host device. In one embodiment, the headphone can comprise a first micro-electro-mechanical system (MEMS) microphone that is configured to receive a first set of acoustic waves, sound, etc., e.g., representing sound generated outside of the ear canal, generate first microphone information based on such sound, and send, utilizing the TDM based bus, the first microphone information directed to the portable electronic device. The portable electronic device can generate feedforward noise cancelation information based on the first microphone information. In this regard, in an embodiment, the feedforward noise cancelation information can represent a noise canceling signal comprising an estimation of portion(s) of the sound that has leaked into the ear canal being phase shifted, and/or a polarity of the estimation of such portion(s) being inverted. For example, the noise canceling signal, being superimposed on a sound output signal, is “subtracted” in amplitude from the sound output signal to cancel, reduce, etc. estimated noise from the ear canal. In this regard, the speaker can be configured to receive, utilizing the TDM based bus, the feedforward noise cancelation information from the portable electronic device, and generate, based on the feedforward noise cancelation information, sound within the portion(s) of the ear canal.

In another embodiment, the earbud can comprise a second MEMS microphone that is configured to receive a second set of acoustic waves, sound, etc., e.g., representing portion(s) of the sound that has been generated outside of the ear canal and leaked into the ear canal, e.g., via outside portion(s) of the earbud, as noise. The second MEMS microphone can generate second microphone information based on the second set of acoustic waves, and send, utilizing the TDM based bus, the second microphone information directed to the portable electronic device. The portable electronic device can generate feedback noise cancelation information based on the second microphone information, e.g., the feedback noise cancelation information representing the portion(s) of the sound that has leaked into the ear canal as noise being phase shifted, and/or a polarity of such noise being inverted. In this regard, the speaker can be configured to receive, utilizing the TDM based bus, the feedback noise cancelation information from the portable electronic device, and generate, based on the feedback noise cancelation information, sound within the portion(s) of the ear canal.

In one embodiment, the earbud can comprise a biometric sensor that is configured to measure, within the portion of the ear canal, information representing a body parameter, e.g., body temperature, etc. of a subject identity.

In another embodiment, the second set of acoustic waves can represent a heartbeat of a subject identity, e.g., representing a sound of blood flow within blood vessels, veins, arteries, etc. of the ear canal. In this regard, the portable electronic device can determine the heartbeat based on a period of the acoustic waves.

In yet another embodiment, the headphone can comprise an inertial sensor, e.g., a gyroscope, an accelerometer, etc. configured to measure information representing a position, direction, movement, etc. of the headphone. In this regard, the portable electronic device can determine, based on the information, the position, direction, movement, etc. of the headphone, and can determine, differentiate, distinguish, select, etc. a sound source, speaker, etc. from a group of sound sources, speakers, etc. based on the determined position, etc. of the headphone, e.g., to pin-point, flag, etc. a person who has been talking.

In other embodiment(s), the headphone can comprise a third MEMS microphone that is configured to receive a third set of acoustic waves, e.g., from a mouth of the subject identity, from the portable electronic device, etc. Further, the third MEMS microphone can be configured to generate third microphone information based on the third set of acoustic waves, and send, utilizing the TDM based bus, the third microphone information directed to the portable electronic device. The portable electronic device can generate sound information based on the third microphone information, e.g., representing speech from the subject, representing a sound from the portable electronic device, etc. In this regard, the speaker can be configured to receive, utilizing the TDM based bus, the sound information from the portable electronic device, and generate, based on the sound information, sound within the portion(s) of the ear canal.

In one embodiment, a headphone can comprise an earbud including a speaker and a first MEMS microphone, and a TDM based bus, e.g., 2-wire bus, 3-wire bus, MIPI SoundWire^{SM} based interface, SLIMbus^{SM}, etc. that electrically couples the earbud to a portable electronic device. The first MEMS microphone can be configured to receive a first set of acoustic waves within a portion of an ear canal, e.g., representing portion(s) of sound that has been generated outside of the ear canal and leaked into the ear canal, e.g., via outside portion(s) of the earbud, as noise. Further, the first MEMS microphone can be configured to generate first microphone information based on the first set of acoustic waves, and send, utilizing the TDM based bus, the first microphone information directed to the portable electronic device.

The portable electronic device can generate feedback noise cancelation information associated with the first microphone information, e.g., the feedback noise cancelation information representing the portion(s) of sound, noise, etc. that has leaked into the ear canal being phase shifted, and/or a polarity of such noise being inverted. In this regard, the speaker can be configured to receive, utilizing the TDM based bus, the feedback noise cancelation information from the portable electronic device, and generate, based on the feedback noise cancelation information, sound within the portion(s) of the ear canal.

In another embodiment, the headphone can comprise a second MEMS microphone that is configured to receive a second set of acoustic waves, sound, etc., e.g., representing sound, noise, etc. that has been generated outside of the ear canal, generate second microphone information based on the second set of acoustic waves, sound, etc., and send, utilizing the TDM based bus, the second microphone information directed to the portable electronic device. The portable electronic device can generate feedforward noise cancelation information based on the second microphone information, e.g., the feedforward noise cancelation information representing the sound, noise, etc. that has been generated outside of the ear canal being phase shifted, and/or a polarity of such sound, noise, etc. being inverted. In this regard, the speaker can be configured to receive, utilizing the TDM based bus, the feedforward noise cancelation information from the portable electronic device, and generate, based on the feedforward noise cancelation information, sound within the portion(s) of the ear canal.

In an embodiment, the first set of acoustic waves can represent a heartbeat of a subject identity, e.g., representing a sound of blood flow within blood vessels, veins, arteries, etc. of the ear canal. In this regard, the portable electronic device can determine the heartbeat based on a period of the acoustic waves.

In yet another embodiment, the headphone can comprise an inertial sensor, e.g., gyroscope, accelerometer, etc. configured to measure a position, movement, etc. of the headphone. In this regard, the portable electronic device can determine, differentiate, distinguish, select, etc. a sound source, speaker, etc. from a group of sound sources, speakers, etc. based on a determined position of the headphone, e.g., to pin-point, flag, etc. a person who has been talking.

In other embodiment(s), the headphone can comprise a third MEMS microphone that is configured to receive a third set of acoustic waves, e.g., from a mouth of the subject identity, from the portable electronic device, etc. Further, the third MEMS microphone can be configured to generate third microphone information based on the third set of acoustic waves, and send, utilizing the TDM based bus, the third microphone information directed to the portable electronic device. The portable electronic device can generate sound information based on the third microphone information, e.g., representing speech from the subject, representing a sound from the portable electronic device, etc. In this regard, the speaker can be configured to receive, utilizing the TDM based bus, the sound information from the portable electronic device, and generate, based on the sound information, sound within the portion(s) of the ear canal.

In one embodiment, a system comprising a processor, e.g., portable electronic device, handheld device, smart phone, cellular phone, etc. can comprise a TDM component and a feedforward noise component. The TDM component can be configured to receive, via a TDM based bus, e.g., 2-wire bus, 3-wire bus, MIPI SoundWire^{SM} based interface, SLIMbus^{SM}, etc. of a headphone jack that electrically couples the system to a headphone, first microphone information from a first MEMS microphone of the headphone that is located outside of an ear canal—the first microphone information representing a sound, noise, etc. that has been generated outside of the ear canal. The feedforward noise component can be configured to determine, based on the first microphone information, feedforward noise cancelation information, e.g., representing a noise canceling signal comprising an estimation of portion(s) of the sound that has leaked into the ear canal being phase shifted, and/or a polarity of the estimation of such portion(s) being inverted. Further, the feedforward noise component can be configured to send, via the TDM based bus, the feedforward noise cancelation information directed to the speaker. In this regard, the speaker can be configured to receive, utilizing the TDM based bus, the feedforward noise cancelation information from the portable electronic device, and generate, based on the feedforward noise cancelation information, sound within the portion(s) of the ear canal.

In another embodiment, the TDM component can be configured to receive, via the TDM based bus, second microphone information from a second MEMS microphone of an earbud of the headphone that is located within a portion of the ear canal. Further, the system can comprise a feedback component that can be configured to determine, based on the second microphone information, feedback noise cancelation information, e.g., representing portion(s) of the sound, noise, etc. that has leaked into the ear canal being phase shifted, and/or a polarity of such noise being inverted. Further, the feedback component can be configured to send, via the TDM based bus, the feedback noise cancelation information directed to the speaker of the headphone, e.g., for generation of a sound by the speaker based on the feedback noise cancelation information.

In yet another embodiment, the TDM component can be configured to receive, via the TDM based bus, biometric sensor information from a biometric sensor of the earbud that is located within the portion of the ear canal. Further, the system can determine, based on the biometric sensor information, a body parameter, e.g., temperature, of a subject identity.

In an embodiment, the system can comprise a sound component that can be configured to determine, based on the second microphone information, a heartbeat of a subject identity, e.g., the second microphone information representing a sound of blood flow within blood vessels, veins, arteries, etc. of the ear canal, and the sound component can be configured to determine the heartbeat based on a period of the sound of the blood flow.

In yet another embodiment, the system can comprise a sensor component. In this regard, the TDM component can be configured to receive, via the TDM based bus, inertial information from an inertial sensor, e.g., gyroscope, accelerometer, etc. of the headphone—the inertial sensor configured to measure information representing a position, direction, movement, etc. of the headphone. The sensor component can be configured to determine, based on the inertial information, the position, direction, movement, etc. of the headphone. In an embodiment, the sensor component can be configured to determine, differentiate, distinguish, select, etc. a sound source, speaker, etc. from a group of sound sources, speakers, etc. based on the determined position, direction, movement, etc. of the headphone, e.g., to pin-point, flag, etc. a person who has been talking.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Aspects of apparatus, devices, processes, and process blocks explained herein can constitute machine-executable instructions embodied within a machine, e.g., embodied in a memory device, computer readable medium (or media) associated with the machine. Such instructions, when executed by the machine, can cause the machine to perform the operations described. Additionally, aspects of the apparatus, devices, processes, and process blocks can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

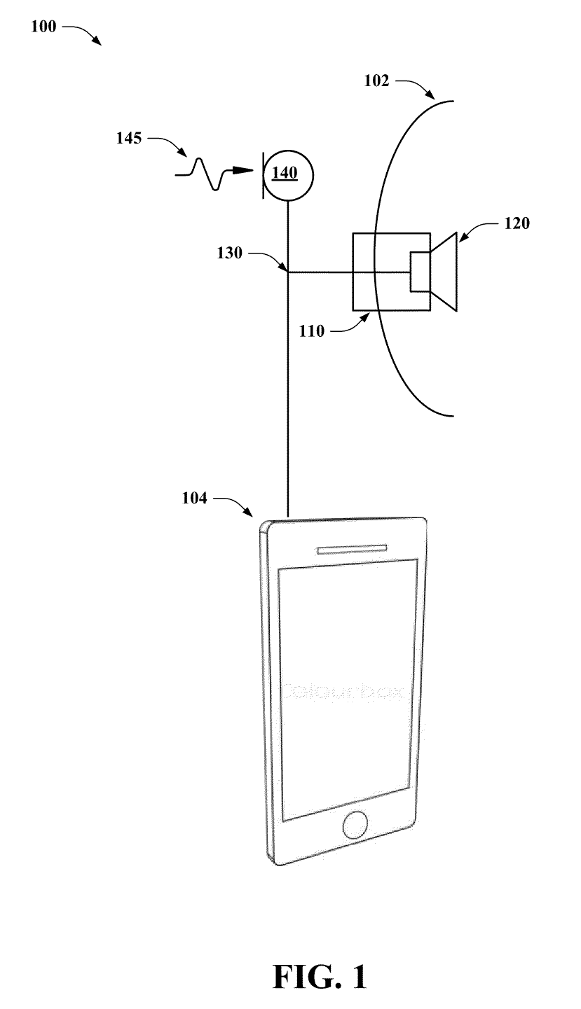

Conventional audio technologies have had some drawbacks with respect to leveraging processing power of a host device when performing headphone noise cancelation. On the other hand, various embodiments disclosed herein can reduce headphone components and improve noise cancelation performance by utilizing TDM based communication between the headphone components and the host device. In this regard, and now referring to FIG. 1, headphone 100 can include earbud 110 that includes speaker 120. As illustrated by FIG. 1, earbud 100 has been placed within portion(s) of an ear canal (not shown) of ear 102 of a subject identity, person, etc. (not shown).

Headphone 100 can include TDM based bus 130, e.g., 2-wire bus, 3-wire bus, MIPI SoundWire^{SM} based interface, SLIMbus^{SM}, etc. that electrically couples earbud 110 to portable electronic device 104, e.g., a handheld device, a smart phone, a cellular phone, etc. In this regard, TDM based bus 130 can comprise a synchronous TDM frame structure, e.g., in which a data line (not shown) (e.g., DATA) and a clock line (not shown) (e.g., CLK) interconnect multiple components of headphone 100 with portable electronic device 104.

For example TDM based bus 130 can electrically couple earbud 110 to a headphone jack (not shown) of portable electronic device 104. Further, headphone 100 can include MEMS microphone 140 that can be configured to receive set of acoustic waves 145, e.g., representing sound generated outside of the ear canal, and generate first microphone information based on the sound. Furthermore, MEMS microphone 140 can send the first microphone information to portable electronic device 104 utilizing TDM based bus 130.

In this regard, portable electronic device 104 can generate feedforward noise cancelation information based on the first microphone information. For example, portable electronic device 104 can estimate, based on the first microphone information, portion(s) of set of acoustic waves 145 that have leaked into the ear canal, e.g., as noise. Further, portable electronic device 104 can generate, determine, etc., based on the estimated portion(s) that have leaked into the ear canal, the feedforward noise cancelation information, e.g., representing a noise canceling signal comprising the estimated noise being phase shifted, and/or a polarity of the estimated noise being inverted. In this regard, speaker 120 can be configured to receive, utilizing TDM based bus 130, the feedforward noise cancelation information from portable electronic device 104, and generate, based on the feedforward noise cancelation information, sound within the ear canal—the noise canceling signal superimposed on a sound output signal to “subtract”, reduce, etc. noise from the ear canal.

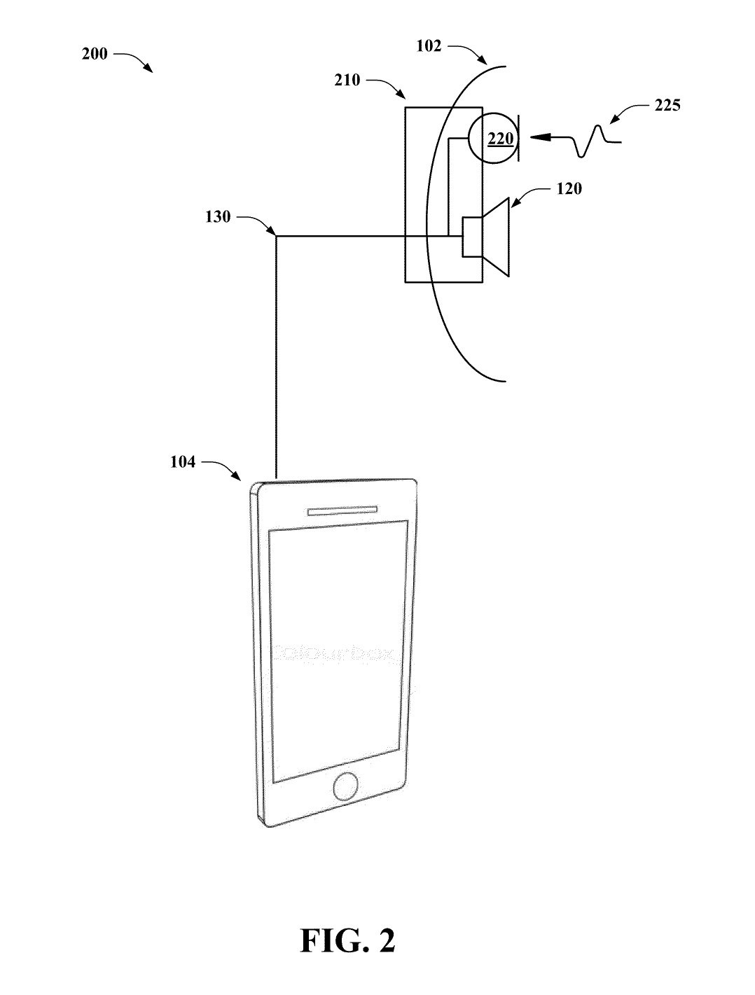

In an embodiment illustrated by FIG. 2, headphone 200 can include TDM based bus 130 electrically coupling portable electronic device 104 to earbud 210, which can include speaker 120 and MEMS microphone 220. MEMS microphone 220 can be configured to receive set of acoustic waves 225, e.g., representing portion(s) of acoustic waves, sound, etc. that have been generated outside of the ear canal, but have leaked into the ear canal, e.g., via outside portion(s) of earbud 210, as noise. MEMS microphone 220 can generate second microphone information based on the noise, and send the second microphone information to portable electronic device 104 utilizing TDM based bus 120.

In this regard, portable electronic device 104 can generate feedback noise cancelation information based on the second microphone information—the feedback noise cancelation information representing a noise canceling signal comprising the noise that has leaked into the ear canal being phase shifted, and/or a polarity of such noise being inverted. In this regard, speaker 120 can be configured to receive, utilizing TDM based bus 130, the feedback noise cancelation information from portable electronic device 104, and generate, based on the feedback noise cancelation information, sound within the ear canal—the noise canceling signal superimposed on a sound output signal to “subtract”, reduce, etc. noise from the ear canal.

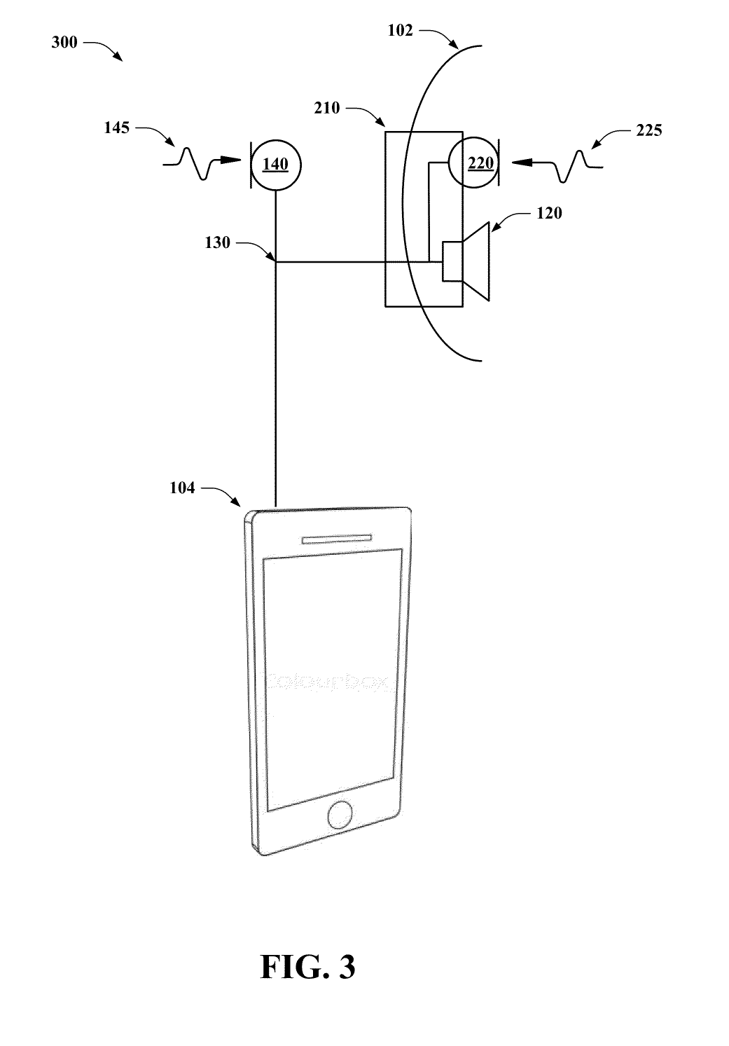

In an embodiment illustrated by FIG. 3, headphone 300 can include TDM based bus 130 electrically coupling portable electronic device 104 to MEMS microphone 140 and earbud 210. In this regard, portable electronic device 104 can generate feedforward noise cancelation information based on the first microphone information received, via TDM based bus 130, from MEMS microphone 140, and can generate feedback noise cancelation information based on the second microphone information received, via TDM based bus 130, from MEMS microphone 220. Further, speaker 120 can be configured to receive, utilizing TDM based bus 130, the feedforward noise cancelation information and the feedback noise cancelation information from portable electronic device 104, and generate, based on such noise cancelation information, sound within the ear canal.

In another embodiment, earbud 210 can include a biometric sensor (not shown) that can be configured to measure, within the ear canal, biometric sensor information representing a body parameter, e.g., body temperature, etc. of the subject identity. Further, TDM based bus 130 can electrically couple portable electronic device 104 to the biometric sensor. In this regard, portable electronic device 104 can receive, via TDM based bus 130, the biometric sensor information, and determine, based on such information, the body parameter.

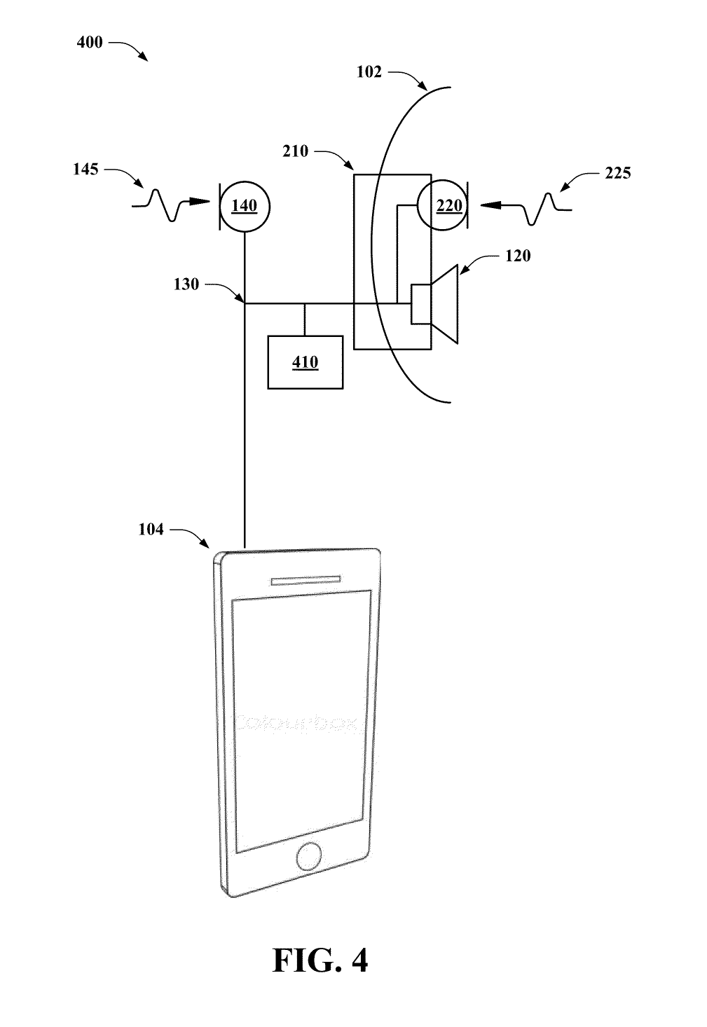

Now referring to FIG. 4, headphone 400 can include inertial sensor 410, in accordance with various embodiments. Inertial sensor 410 can comprise a gyroscope, an accelerometer, etc. configured to measure inertial information representing a position, movement, etc. of headphone 400. Further, inertial sensor 410 can be configured to send, via TDM based bus 130, the inertial information to portable electronic device 104. In this regard, portable electronic device 104 can determine, based on the inertial information, the position, movement, etc. of headphone 400, e.g., for differentiating, distinguishing, selecting, etc. a sound source, speaker, etc. from a group of sound sources, speakers, etc., for example, to pin-point, flag, etc. a person who has been talking.

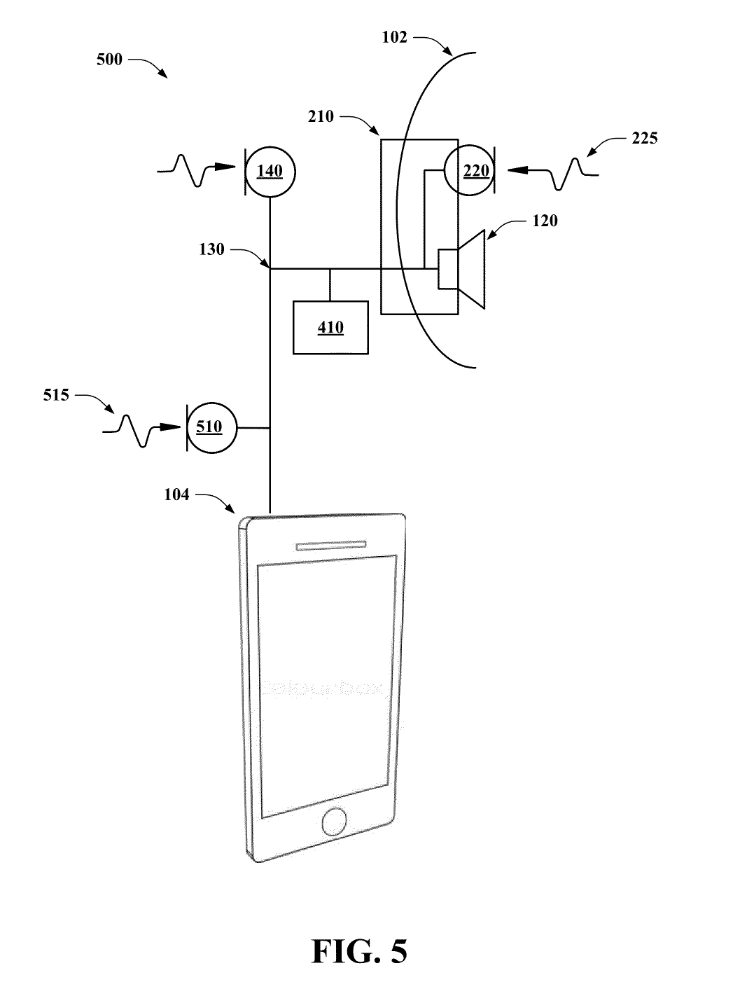

FIG. 5 illustrates a headphone (500) including a MEMS microphone (510), in accordance with various embodiments. MEMS microphone 510 can be configured to receive set of acoustic waves 515, e.g., from a mouth of the subject identity, from portable electronic device 104, etc., and generate third microphone information based on set of acoustic waves 415. Further, MEMS microphone 510 can send, utilizing TDM based bus 130, the third microphone information to portable electronic device 104. Portable electronic device 104 can generate sound information based on the third microphone information, e.g., representing speech from the subject, representing a sound emitted from portable electronic device 104, etc. In this regard, speaker 120 can be configured to receive, utilizing TDM based bus 130, the sound information from portable electronic device 104, and generate, based on the sound information, sound within the portion(s) of the ear canal.

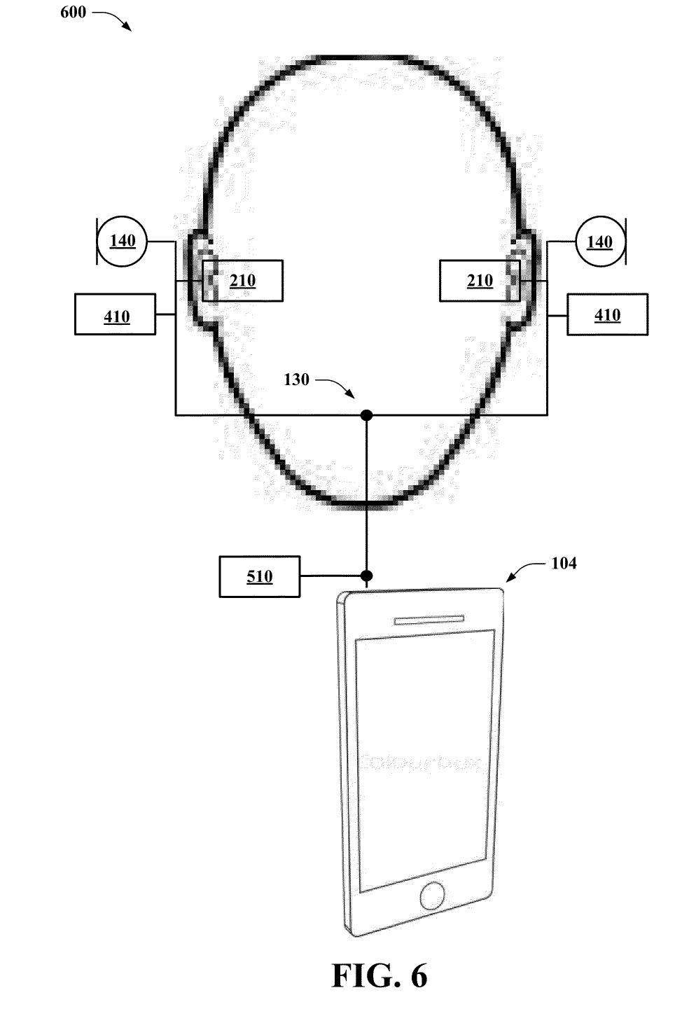

FIG. 6 illustrates a headphone (600) including a pair of MEMS microphones 140, a pair of earbuds 210, a pair of inertial sensors 410, and MEMS microphone 510 electrically coupled to portable electronic device 104. In this regard, the pair of MEMS microphones 140 can be configured to receive set of acoustic waves 145, e.g., representing sound generated outside of respective ear canals. Further, the pair of MEMS microphones 140 can generate first microphone information based on the sound, and send the first microphone information to portable electronic device 104 utilizing TDM based bus 130. In this regard, as described above, portable electronic device 104 can generate feedforward noise cancelation information based on the first microphone information. Speaker 120 can be configured to receive, utilizing TDM based bus 130, the feedforward noise cancelation information from portable electronic device 104, and generate, based on the feedforward noise cancelation information, sound within the respective ear canals—the feedforward noise cancelation information representing noise canceling signals superimposed on respective sound output signals to “subtract”, reduce, etc. noise from the respective ear canals.

MEMS microphones 220 of the pair of earbuds 210 can be configured to receive sets of acoustic waves 225, e.g., representing portion(s) of acoustic waves, sound, etc. that have been generated outside of respective ear canals, but have leaked into such ear canals, e.g., via outside portion(s) of the pair of earbuds 210, as noise. Further, MEMS microphones 220 of the pair of earbuds 210 can generate second microphone information based on the noise, and send the second microphone information to portable electronic device 104 utilizing TDM based bus 130. In this regard, as described above, portable electronic device 104 can generate feedback noise cancelation information based on the second microphone information. Speaker 120 can be configured to receive, utilizing TDM based bus 130, the feedback noise cancelation information from portable electronic device 104, and generate, based on the feedback noise cancelation information, sound within the respective ear canals—the feedback noise cancelation information representing noise canceling signals superimposed on the respective sound output signals to subtract, reduce, etc. noise from the respective ear canals.

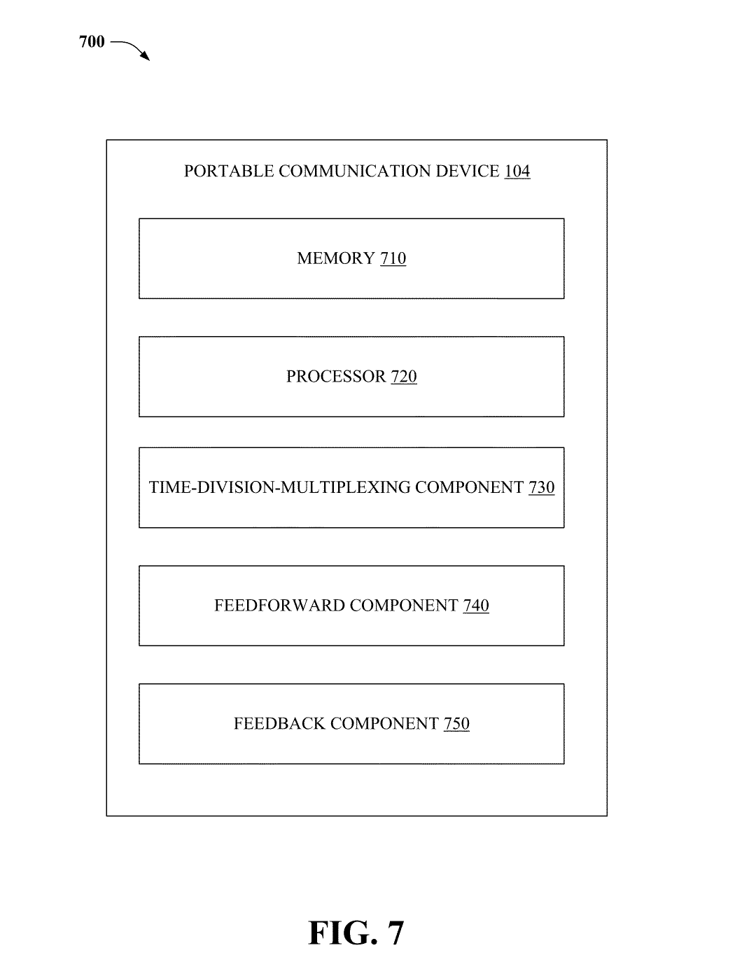

Referring now to FIG. 7, a block diagram (700) of portable electronic device 104, e.g., handheld device, smart phone, cellular phone, etc. is illustrated, in accordance with various embodiments. Portable electronic device 104 can include memory 710 that stores executable instructions, and processor 720 that can execute the executable instructions to facilitate performance of operations via TDM component 730, feedforward component 740, and feedback component 750. TDM component 730 can be configured to receive, via TDM based bus 130, e.g., 2-wire bus, 3-wire bus, etc. of a headphone jack (not shown) that electrically couples portable electronic device 104 to a headphone (e.g. 100, 200, 300, 400, 500, 600, etc.), first microphone information from a first MEMS microphone of the headphone that is located outside of an ear canal—the first microphone information representing a sound that has been generated outside of the ear canal. Feedforward noise component 740 can be configured to determine, based on the first microphone information, feedforward noise cancelation information, e.g., representing a noise canceling signal comprising an estimation of portion(s) of the sound that has leaked into the ear canal being phase shifted, and/or a polarity of the estimation of such portion(s) being inverted. Further, feedforward noise component 740 can be configured to send, via TDM based bus 130, the feedforward noise cancelation information to speaker 120 of earbud 210. In this regard, speaker 120 can be configured to receive, utilizing TDM based bus 130, the feedforward noise cancelation information from portable electronic device 104, and generate, based on the feedforward noise cancelation information, sound within the portion(s) of the ear canal.

In another embodiment, TDM component 730 can be configured to receive, via TDM based bus 130, second microphone information from a second MEMS microphone of an earbud of the headphone that is located within a portion of the ear canal. Feedback component 750 can be configured to determine, based on the second microphone information, feedback noise cancelation information, e.g., representing portion(s) of the sound that has leaked into the ear canal as noise being phase shifted, and/or a polarity of such noise being inverted. Further, feedback component 750 can be configured to send, via TDM based bus 130, the feedback noise cancelation information to speaker 120 of earbud 220. In this regard, speaker 120 can be configured to receive, utilizing TDM based bus 130, the feedback noise cancelation information from portable electronic device 104, and generate, based on the feedback noise cancelation information, sound within the portion(s) of the ear canal.

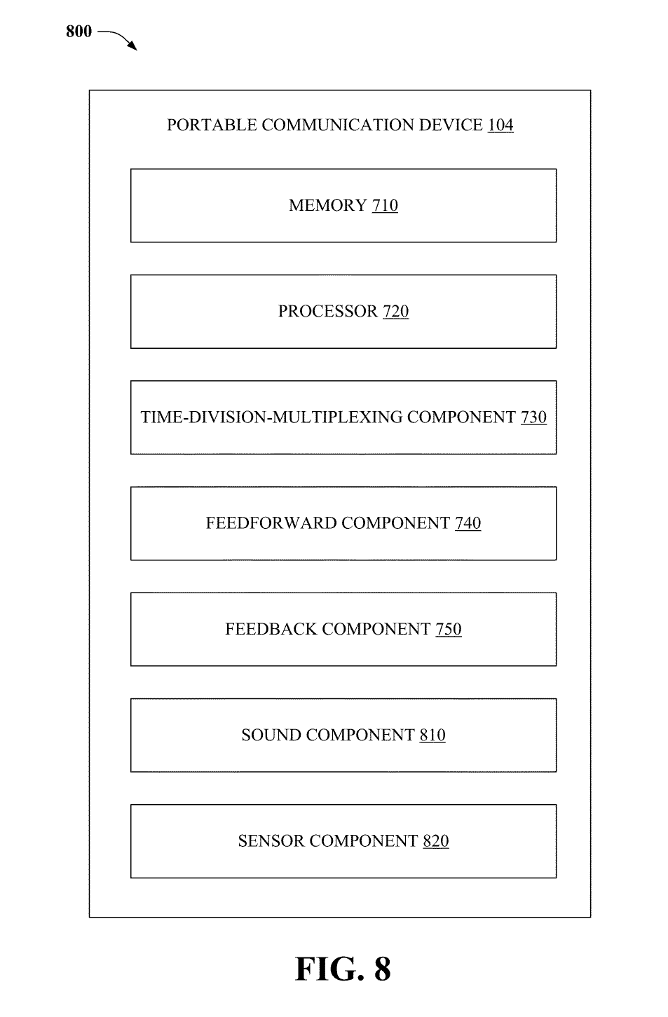

FIG. 8 illustrates a block diagram (800) of portable communication device 104 including sound component 810 and sensor component 820, in accordance with various embodiments. Sound component 810 can be configured to determine, based on the second microphone information, a heartbeat of a subject identity, e.g., the second microphone information representing a sound of blood flow within blood vessels, veins, arteries, etc. of the ear canal, e.g., based on a period of the sound of the blood flow.

Sensor component 820 can be configured to determine, based on inertial information received, via TDM component 730, from an inertial sensor, e.g., gyroscope, accelerometer, etc. of the headphone—the inertial sensor configured to measure information representing a position, direction, movement, etc. of the headphone. Further, sensor component 820 can be configured to determine, based on the inertial information, the position, direction, movement, etc. of the headphone. In an embodiment, sensor component 820 can be configured to determine, differentiate, distinguish, select, etc. a sound source, speaker, etc. from a group of sound sources, speakers, etc. based on the determined position, direction, movement, etc. of the headphone, e.g., to pin-point, flag, etc. a person who has been talking.

In one embodiment, sensor component 820 can be configured to determine a body parameter, e.g., body temperature, etc. of the subject identity based on biometric data, sensor information, etc. received, via TDM component 730, from a biometric sensor (not shown) of the earbud of the headphone that is located within the portion of the ear canal.

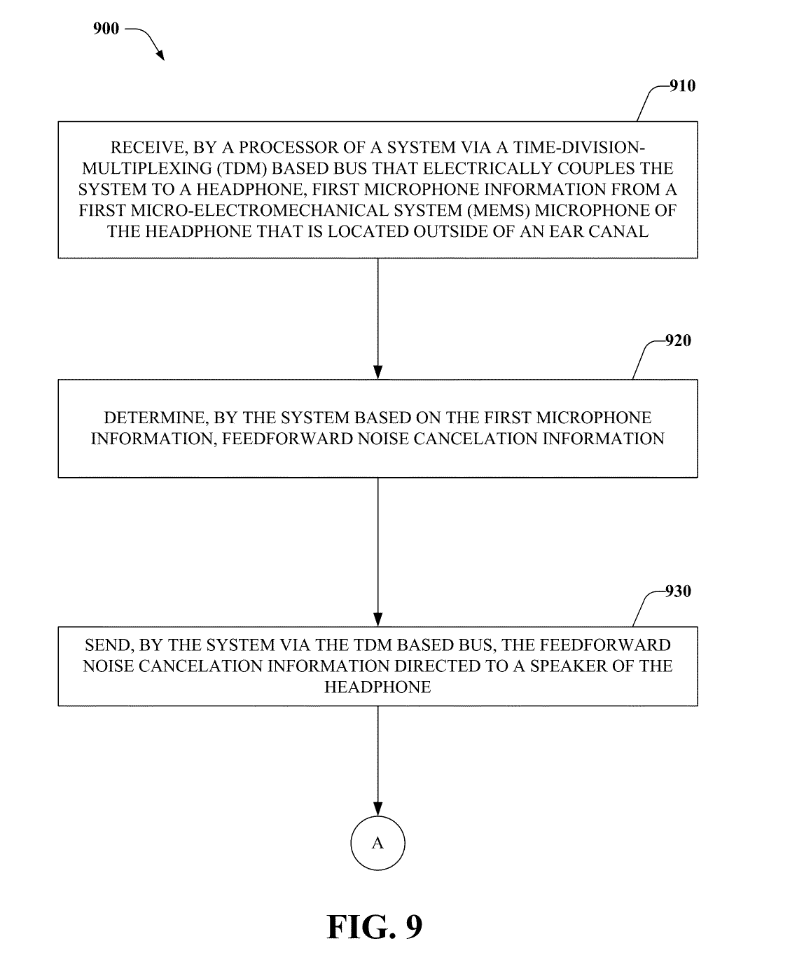

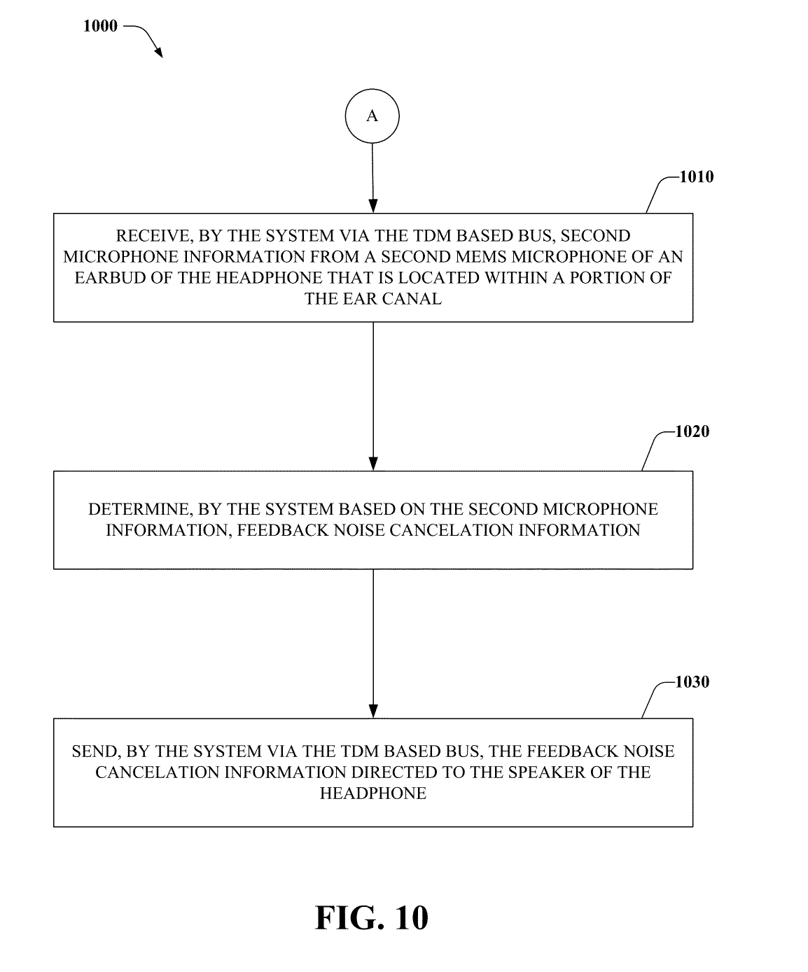

FIGS. 9-10 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that methodologies disclosed hereinafter and throughout this specification are capable of being stored on an article of manufacture to facilitate transporting and transferring such methodologies to computers, processors, processing components, etc. The term article of manufacture, as used herein, is intended to encompass a computer program accessible from any computer-readable device, carrier, or media.

Referring now to FIGS. 9 and 10, processes 900 and 1000 performed by a system, e.g., portable electronic device, e.g., 104, are illustrated, respectively, in accordance with various embodiments. At 910, first microphone information can be received by the system, via a TDM based bus that electrically couples the system to a headphone, from a first MEMS microphone of the headphone that is located outside of an ear canal. At 920, feedforward noise cancelation information can be determined by the system via the first microphone information. At 930, the feedforward noise cancelation information can be sent by the system, via the TDM based bus, directed to a speaker of the headphone.

At 1010, second microphone information can be received by the system, via the TDM based bus, from a second MEMS microphone of an earbud of the headphone that is located within a portion of the ear canal. At 1020, feedback noise cancelation information can be determined by the system based on the second microphone information. At 1030, the feedback noise cancelation information can be sent by the system, via the TDM based bus, directed to the speaker of the headphone.

As it employed in the subject specification, the terms “processor”, “processing component”, etc. can refer to substantially any computing processing unit or device, e.g., processor 1120, comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Further, a processor can exploit nano-scale architectures such as, but not limited to, molecular and quantum-dot based transistors, switches and gates, e.g., in order to optimize space usage or enhance performance of mobile devices. A processor can also be implemented as a combination of computing processing units, devices, etc.

In the subject specification, terms such as “memory” and substantially any other information storage component relevant to operation and functionality of portable electronic device(s) and/or device(s) disclosed herein, e.g., memory 1110, refer to “memory components,” or entities embodied in a “memory,” or components comprising the memory. It will be appreciated that the memory can include volatile memory and/or nonvolatile memory. By way of illustration, and not limitation, volatile memory, can include random access memory (RAM), which can act as external cache memory. By way of illustration and not limitation, RAM can include synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and/or Rambus dynamic RAM (RDRAM). In other embodiment(s) nonvolatile memory can include read only memory (ROM), programmable ROM (PROM), electrically programmable ROM (EPROM), electrically erasable ROM (EEPROM), or flash memory. Additionally, the MEMS microphones and/or devices disclosed herein can comprise, without being limited to comprising, these and any other suitable types of memory.

By way of illustration, and not limitation, nonvolatile memory, for example, can be included in non-volatile memory 1122 (see below), disk storage 1124 (see below), and/or memory storage 1146 (see below). Further, nonvolatile memory can be included in read only memory (ROM), programmable ROM (PROM), electrically programmable ROM (EPROM), electrically erasable ROM (EEPROM), or flash memory. Volatile memory 1220 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

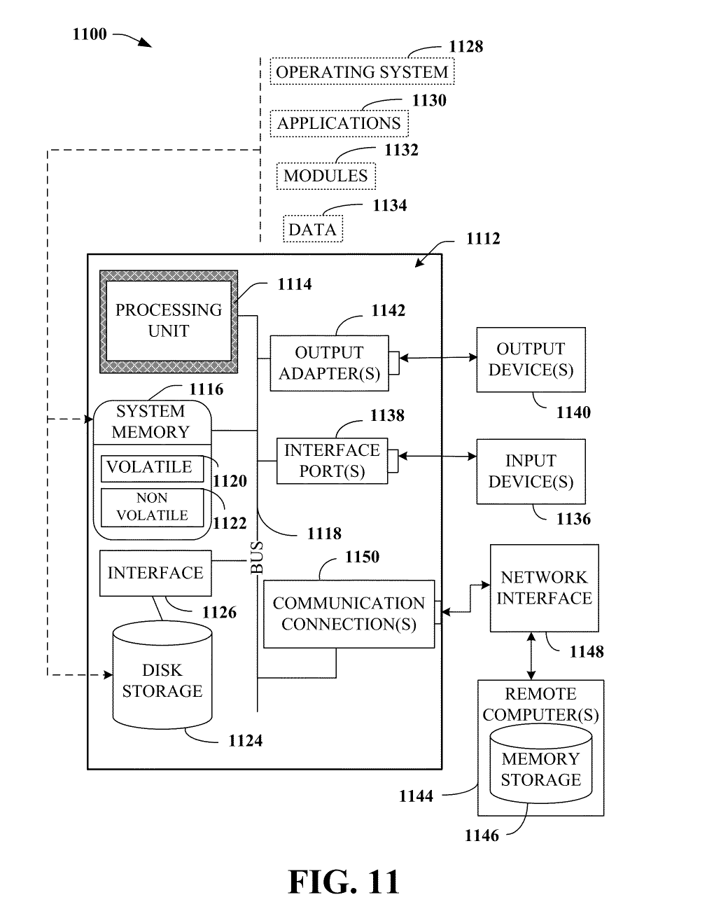

In order to provide a context for the various aspects of the disclosed subject matter, FIG. 11, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 11, a block diagram of a computing system 1100 operable to execute the disclosed systems and methods is illustrated, in accordance with an embodiment. Computer 1112 comprises a processing unit 1114, a system memory 1116, and a system bus 1118. System bus 1118 couples system components comprising, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1116 comprises volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can comprise ROM, PROM, EPROM, EEPROM, or flash memory. Volatile memory 1120 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also comprises removable/non-removable, volatile/non-volatile computer storage media. FIG. 11 illustrates, for example, disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users and computer resources described in suitable operating environment 1100. Such software comprises an operating system 1128. Operating system 1128, which can be stored on disk storage 1124, acts to control and allocate resources of computer system 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user can enter commands, e.g., via UI component 510, or information into computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1114 through system bus 1118 via interface port(s) 1138. Interface port(s) 1138 comprise, for example, a serial port, a parallel port, a game port, a universal serial bus (USB), a wireless based port, e.g., Wi-Fi, Bluetooth, etc. Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140, like display devices, light projection devices, monitors, speakers, and printers, among other output devices 1140, which use special adapters. Output adapters 1142 comprise, by way of illustration and not limitation, video and sound devices, cards, etc. that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically comprises many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically and/or wirelessly connected via communication connection 1150. Network interface 1148 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can comprise, for example, internal and external technologies such as modems, comprising regular telephone grade modems, cable modems and DSL modems, wireless modems, ISDN adapters, and Ethernet cards.

The computer 1112 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1112 can connect to other devices/networks by way of antenna, port, network interface adaptor, wireless access point, modem, and/or the like.

The computer 1112 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A headphone, comprising:
an earbud comprising a speaker; and
a time-division-multiplexing (TDM) based bus that electrically couples the earbud to a portable electronic device; and
a first micro-electro-mechanical system (MEMS) microphone that is configured to receive a first set of acoustic waves outside of an ear canal, generate first microphone information based on the first set of acoustic waves, and send, utilizing the TDM based bus, the first microphone information directed to the portable electronic device, wherein the speaker is configured to receive, utilizing the TDM based bus, feedforward noise cancelation information associated with the first microphone information from the portable electronic device, and generate, based on the feedforward noise cancelation information, sound within a portion of the ear canal.

2. The headphone of claim 1, wherein the earbud further comprises a second MEMS microphone that is configured to receive a second set of acoustic waves within the portion of the ear canal, generate second microphone information based on the second set of acoustic waves, and send, utilizing the TDM based bus, the second microphone information directed to the portable electronic device, wherein the speaker is configured to receive, utilizing the TDM based bus, feedback noise cancelation information associated with the second microphone information from the portable electronic device, and generate, based on the feedback noise cancelation information, the sound within the portion of the ear canal.

3. The headphone of claim 2, wherein the earbud further comprises a biometric sensor that is configured to measure, within the portion of the ear canal, biometric information representing a body parameter of a subject identity.

4. The headphone of claim 3, wherein the body parameter comprises a body temperature of the subject identity.

5. The headphone of claim 2, wherein the second set of acoustic waves comprises a portion of the first set of acoustic waves received within the portion of the ear canal.

6. The headphone of claim 1, wherein the second set of acoustic waves corresponds to a measurement of a heartbeat of a subject identity.

7. The headphone of claim 1, further comprising:
an inertial sensor configured to measure a position of the headphone.

8. The headphone of claim 1, further comprising a third MEMS microphone that is configured to receive a third set of acoustic waves, generate third microphone information based on the third set of acoustic waves, and send, utilizing the TDM based bus, the third microphone information directed to the portable electronic device, wherein the speaker is configured to receive, utilizing the TDM based bus, sound information associated with the third microphone information from the portable electronic device, and generate, based on the sound information, the sound within the portion of the ear canal.

9. The headphone of claim 1, wherein the TDM based bus comprises a pair of wires coupled between the earbud and the portable electronic device.

10. A headphone, comprising:
an earbud comprising a speaker and a first micro-electro-mechanical system (MEMS) microphone; and
a time-division-multiplexing (TDM) based bus that electrically couples the earbud to a portable electronic device, wherein the first MEMS microphone is configured to receive a first set of acoustic waves within a portion of an ear canal, generate first microphone information based on the first set of acoustic waves, and send, utilizing the TDM based bus, the first microphone information directed to the portable electronic device, wherein the speaker is configured to receive, utilizing the TDM based bus, feedback noise cancelation information associated with the first microphone information from the portable electronic device, and generate, based on the feedback noise cancelation information, sound within the portion of the ear canal.

11. The headphone of claim 10, further comprising a second MEMS microphone that is configured to receive a second set of acoustic waves outside of the ear canal, generate second microphone information based on the second set of acoustic waves, and send, utilizing the TDM based bus, the second microphone information directed to the portable electronic device, wherein the speaker is configured to receive, utilizing the TDM based bus, feedforward noise cancelation information associated with the second microphone information from the portable electronic device, and generate, based on the feedforward noise cancelation information, the sound within the portion of the ear canal.

12. The headphone of claim 11, wherein the first set of acoustic waves comprises a portion of the second set of acoustic waves received within the portion of the ear canal.

13. The headphone of claim 10, wherein the first set of acoustic waves corresponds to a measurement of a heartbeat of a subject identity.

14. The headphone of claim 10, further comprising:
an inertial sensor configured to measure a position of the headphone.

15. The headphone of claim 10, further comprising a third MEMS microphone that is configured to receive a third set of acoustic waves, generate third microphone information based on the third set of acoustic waves, and send, utilizing the TDM based bus, the third microphone information directed to the portable electronic device, wherein the speaker is configured to receive, utilizing the TDM based bus, sound information associated with the third microphone information from the portable electronic device, and generate, based on the sound information, the sound within the portion of the ear canal.

16. The headphone of claim 8, wherein the TDM based bus comprises a pair of wires coupled between the earbud and the portable electronic device.

17. A system, comprising:
a processor; and
a memory that stores executable instructions that, when executed by the processor, facilitate performance of operations, the operations comprising:
receiving, via a time-division-multiplexing (TDM) based bus that electrically couples the system to a headphone, first microphone information from a first micro-electro-mechanical system (MEMS) microphone of the headphone that is located outside of an ear canal;
determining, based on the first microphone information, feedforward noise cancelation information; and
sending, via the TDM based bus, the feedforward noise cancelation information directed to a speaker of the headphone.

18. The system of claim 17, wherein the operations further comprise:
receiving, via the TDM based bus, second microphone information from a second MEMS microphone of an earbud of the headphone that is located within a portion of the ear canal;
determining, based on the second microphone information, feedback noise cancelation information; and
sending, via the TDM based bus, the feedback noise cancelation information directed to the speaker of the headphone.

19. The system of claim 18, wherein the operations further comprise:
receiving, via the TDM based bus, biometric sensor information from a biometric sensor of the earbud that is located within the portion of the ear canal; and
determining, based on the biometric sensor information, a body parameter of a subject identity.

20. The system of claim 19, wherein the body parameter comprises a body temperature of the subject identity.

21. The system of claim 18, wherein the operations further comprise:
determining, based on the second microphone information, a heartbeat of a subject identity.

22. The system of claim 17, wherein the operations further comprise:
receiving, via the TDM based bus, inertial information from an inertial sensor of the headphone; and
determining, based on the inertial information, a position of the headphone.

23. The system of claim 22, wherein the operations further comprise:
receiving, via the TDM based bus, sound information from the speaker of the headphone; and
determining, based on the determined position of the headphone, a sound source associated with the sound information.

24. The system of claim 17, wherein the TDM based bus comprises a pair of wires coupled between the system and the headphone.
